(19) United States
(12) Patent Application Publication
(10) Pub. No.: US 2007/0157395 A1
(43) Pub. Date: Jul. 12, 2007

(54) Method for preparing insecticidal textiles by a dyeing process of synthetic fibres with pyrethoids

(76) Inventor: Gongping Cao, Shanghai (CN)

Correspondence Address: NIXON & VANDERHYE, PC, 901 NORTH GLEBE ROAD, 11TH FLOOR, ARLINGTON, VA, 22203, US

(21) Appl. No.: 11/517,427

(22) Filed: Sep. 8, 2006

(30) Foreign Application Priority Data
Jan. 12, 2006 (CN) 200610023262.5

(51) Int. Cl. C11D 3/00

(52) U.S. Cl. 8/115.51

(57) ABSTRACT

The present invention relates to a method for preparing insecticidal textiles, which is characterized in that, by depending on the dyeing mechanism, synthetic fabrics or yarns are dyed with pyrethroids by an exhaust dyeing or a pad dyeing process. The said synthetic fibre fabrics include multifilament, monofilament, and/or staple yarn fabrics of polyester, polyamide, polyurethane, polypropylene, polyethylene, polyacryl-nitrile, or polyvinyl chloride, and their blended or interlaced fabrics with natural fibers. The said yarns are multifilament, monofilament, and/or staple yarns of the above fibers or their blended and interlaces yarns with natural fibers. The said pyrethroids are hydrophobic and insoluble in water, have a molecular weight of less than 700 and a decomposition temperature of higher than the heat treatment temperature for exhaust dyeing or pad dyeing, and have at least one of the following groups —OH, —CN, —NH₂, —NHR, —NR₂, —NHCOR, —I, —Cl, —Br, —NO₂, —SONH₂,

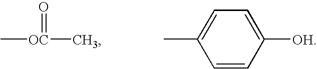

The advantages of the present invention are that the production process is short with operation being convenient. One or more kinds of pyrethroids can be selected against different insect pests with controllable dosage.

The present application claims benefit of CN 200610023262.5 filed Jan. 12, 2006, the entire contents of which is incorporated herein by reference.

### TECHNICAL FIELD

The present invention relates to a method for preparing insecticidal textiles, particularly to a method of adding pyrethroids into synthetic fibers by use of a dyeing process of the textile industry to prepare the insecticidal textiles.

### BACKGROUND OF THE INVENTION

The pyrethrum contains the insecticidal pyrethrin. The pyrethroids are the synthesized analogs of the pyrethrin according to the structure of the natural pyrethrin. And they have better resistance to light and heat than the natural pyrethrin. So that they can be used to prepare daily use insecticidal clothings, mosquito nets and agricultural insecticidal nets etc.

At present, there are mainly two processes for preparing insecticidal fabrics. One is to combine the pyrethroids in the spinning dope to prepare insecticidal fibers. And the other is to coat the pyrethroids onto the surface of fabrics by spraying or pad dyeing, etc.

According to Technical Manual of Formulation of Sanitary Insecticide in 2000 (Issue number. ISBN7-5025-2987-X/TQ.1305), the insecticidal polyethylene fibers of OLYSET from Sumitomo Chemical Co., Ltd. of Japan is produced by adding the component of permethrin into the spinning dope of the high density polyethylene fiber in amount of 2% of the high density polyethylene. In use, the insecticide is released onto the surface of the fibers to effect insect proof. The fabric produced by this process has a good fastness of pyrethroids. It is convenient in production. And it isn't likely to cause the environmental pollution. However, the permethrin has poor disinsection or insecticidal efficiency and has to be used in a great amount. Moreover, the obtained fibers are not easily spun and produce course fabrics. The insecticidal fibers and yarns cannot be spun with the material made from recycled polyethylene (such as recycled coke bottles). And the temperature of the spinning dope is higher than 250° C., easy to decompose permethrin

CN patent No. ZL03129663.7 disclosed a process for preparing insecticidal fabrics, which includes pad dyeing the fabrics with a treating solution formulated by the components of pyrethroids, etc under normal temperature, and then performing the heat treatment to fix the components of pyrethroids, etc onto the fabrics. This process has the advantages of accurate control of the contents of each component, reproducibility, high productivity, low cost and short production process. However, even if the formulation is modified to prolong the insecticidal effect, the components can't infiltrate into the inside of the fiber molecules.

China application No. 96106001.8 filed by Graniteville Company, US disclosed a process of dipping the fabrics into a bath containing permethrin to prepare the washable insecticidal fabrics. However, this process also has to coat the permethrin onto the surface of the fabrics with the effective period being relatively short.

According to U.S. Pat. No. 5,198,287 published on Mar. 30, 1993, the permethrin is added onto the coating layer of the inner surface of the tent fabrics. And according to U.S. Pat. No. 5,252,387 published on Oct. 12, 1993, a barrier layer is formed on the permethrin layer of the fabrics to protect the permethrin from UV light and oxygen. However, both of these two patents adopt the method to add permethrin onto the surface of the fabrics by a dipping or coating process.

At present, there is no report on a method that the pyrethroids are directly dyed into synthetic fibers by use of a dyeing process.

### DISCLOSURE OF THE INVENTION

In order to overcome the defects in the above-mentioned processes, the present invention provides a method for preparing insecticidal textiles by dyeing the pyrethroids into synthetic fibers based on dyeing mechanism.

The present invention is characterized by dying pyrethroids onto synthetic fiber fabrics by an exhaust dyeing or a pad dyeing process, or into the synthetic fiber yarns by an exhaust dyeing process based on the use of dyeing mechanisms. The pyrethroids can be regarded as the pigments without chromophoric groups.

The said synthetic fiber fabrics include multifilament, monofilament, and/or staple yarn fabrics of thermoplastic synthetic fibers which are glassy and highly elastic, etc, such as polyester, polyamide, polypropylene, polyethylene, polyacryl-nitrile, polyvinyl chloride or polyurethane fibers, and their blended or interlaced fabrics with natural fibers. The yarns of the present invention are multifilament, monofilament, and/or staple yarns of the above fibers, and their blended or interlaced yarns with natural fibers.

When heated, the synthetic fibers swell with increasing temperatures so that the interspaces between chain segments of the fiber molecules increase and the structure of the fiber molecules becomes loose. The pyrethroids of lower molecular weight may enter the inside of the fibers and are coagulated in the fibers after cooling. In use, the pyrethroids inside the synthetic fibers migrate continuously to the surface of the fibers to produce the insect-proof fibers. In addition, the selected pyrethroids should be hydrophobic and insoluble in water, have a molecular weight of less than 700 and a decomposing temperature of higher than the heat treatment temperature for exhaust dyeing or pad dyeing. Pyrethroids of the present invention preferably also contain polar groups, such as —OH, —CN, —NH₂, —NHR, —NR₂, —NHCOR, —I, —Cl, —Br, —NO₂, —SONH₂,

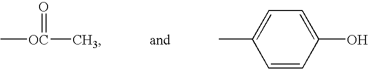

etc. The pyrethroids having one or more above groups can bind more readily to the fiber molecules through these groups.

The fabrics are dyed directly with the pyrethroids by use of a conventional dyeing method of exhaust dyeing and pad dyeing processes. Since the fibers have different glass temperatures and heat resistances, the processing temperature for them in dyeing is also different. The processing temperature and time for dyeing the various fabrics or yarns with the pyrethroids are listed in the following table.

| | Exhaust | | Heat | |
|---|---|---|---|---|
| | dyeing | Exhaust | temperature | Heat time |
| Kind of | temperature | dyeing | for pad | for pad |
| fibers | (° C.) | time(min) | dyeing (° C.) | dyeing(min) |
| Polypropylene | 60–105 | 10–120 | 85–155 | 0.2–6 |
| Polyester | 60–140 | 10–120 | 140–215 | 0.2–4 |
| polyamide | 65–110 | 10–120 | 130–200 | 0.2–4 |
| polyurethane | 65–110 | 10–120 | 150–200 | 0.2–4 |
| polyvinyl chloride | 50–90 | 10–120 | 50–100 | 0.3–7 |
| Polyacryl-nitrile | 60–120 | 10–120 | 120–200 | 0.2–4 |
| polyethylene | 40–90 | 10–120 | 50–100 | 0.3–7 |

Except for the above temperature requirement, other finishing processes, such as washing, are all the same as conventional dyeing methods.

When dyeing the blended fabrics of synthetic fibers with natural fibers, such as the blended fabric of polyester with cotton, since the pyrethroids can't be dyed into the cotton fiber, adhesives and preferably added into the pad dyeing solution to ensure the pyrethroids are adhered to the surface of the cotton fiber. As for some synthetic fibers with the pyrethroids infiltrated into or bleeded out slightly, the adhesives can also be added into the pad dyeing solution to increase the content of the pyrethroids on the surface of the fibers to compensate for any deficiency due to the bleeding of the pyrethroids.

In the exhaust dyeing and pad dyeing processes, the pyrethroids usually are added into the exhaust dyeing or pad dyeing solution in the form of their emulsifiable solutions. The emulsifiable solutions can consist of the technical materials of pyrethroids, xylene solvent, and the agricultural emulsifier 2201 (produced by Nan Jing Zhongshan Chemical Co., Ltd of China). For example, when preparing 10% deltamethrin emulsifiable solution, 5000 g of technical deltamethrin is added into 30 L of xylene solvent under stirring at the temperature of 30 to 50° C. for 30 minutes. After all the solids being dissolved, 5 L of the agricultural emulsifier 2201 is added, and the xylene solvent is added until the total volume reached 50 L, and then the mixture is continued to be stirred at the temperature of 30 to 50° C. for 30 minutes, so that the final product is achieved. When preparing the emulsifiable solutions of other pyrethroids, the ratio of xylene solvent and agricultural emulsifier 2201 is as described above.

The present invention has the advantages of being a straightforward production process which is convenient in operation with operation temperature being sufficiently low so that a large volume of pyrethroids of lower decomposition temperature can be used in production. One or more kinds of pyrethroids cam be selected to be used against different insect pests with controllable dosage. The yarns of the present invention are preferably used to produce insecticidal blankets and rugs.

### DETAILED DESCRIPTION OF THE INVENTION

Considering the similar molecular structure between the pyrethroids and the disperse dyes, It is suggested that the other processing conditions, except for the temperature and time for the exhaust dyeing and the heat treatment of pad dyeing provided in the present invention, can adopt a conventional process of disperse dyeing. The pyrethroid emulsifiable solutions can be used in combination with some functional additives, such as UV resistance, flame retardant, antibacterial, dirt repellent and antistatic agents, etc. in the exhaust dyeing or pad dyeing solution after the compatibility tests.

In addition, the pyrethroids of low efficiency are preferably applied to the fibers of lower glass temperature and good permeability whilst the pyrethroids of high efficiency are preferably applied to the fibers of higher glass temperature and poor permeability. The various fibers are listed below in an order of glass temperature from high to low:

Polyacryl-nitrile>polyvinyl chloride>Polyester>polyamide>polyurethane>Polypropylene>polyethylene.

Several pyrethroids are listed below in an order of efficiency from high to low:

Deltamethrin>clocythrin>cypermethrin>d-phenothrin>permethrin

### EMBODIMENTS

### Example 1

### Preparation of Insecticidal Polyethylene Fabric

The density of the fabric was 70 g/m², and the target content of the deltamethrin was 100 mg/m².

Composition of the exhaust dyeing solution:

| Composition | Amount | |
|---|---|---|
| 10% of deltamethrin emulsifiable solution | 0.01 | L |
| Water | Adding to 5.0 | L |

100 g of polyethylene fabric was immersed into the exhaust dyeing solution (while dipping 100 g of all cotton fabric as the blank control). The exhaust dyeing solution constantly circulates from down to up. The temperature of the exhaust dyeing solution was increased by 2° C. every two minutes until 80˜85° C., and maintained for 30 minutes. The fabric was dried after removing the water by a centrifugal extractor.

According to the method in measuring the surface concentration and releasing of pyrchroids of insecticidal mosquito net discussed by CIPAC (Collaborative International Pesticides Analytical Council (URL: cipac.org)) in 2005, the surface of the produced polyethylene fabric was firstly washed with acetone and serves as sample A. A part of sample A was put into the xylene solvent at 70° C. with stirring to dissolve, and then the acetone was added dropwise to produce precipitation in the solution. The precipitation was filtered out. The resultant solution was assayed with HPLC and it was found that the content of the deltamethrin was 370 mg/m². Next, the sample A was placed in an oven at 70° C. for 120 minutes, and then was washed with the solvent (80% of isooctane and 20% dioxane) to obtain the sample B. The washing solution was assayed with HPLC and it was found that the content of deltamethrin was 106 mg/m². Again, the sample B was placed in an oven at 70° C. for 120 minutes, and was washed with the above solvent to obtain the sample C. The washing solution was also assayed with HPLC and it was found that the content of deltamethrin was 15.3 mg/m². The releasing amount of pyrethroid in above fabrics was measured one after another and their washability was thus estimated. The test results are listed in the following table:

| | | | Releasing | Releasing | Releasing |
|---|---|---|---|---|---|
| | | Releasing | amount | amount | amount |
| | | amount | after | after | after |
| | Content of | after first | second | third | fourth |
| | fiber | baking | baking | baking | baking |
| Sample | (mg/m²) | (mg/m²) | (mg/m²) | (mg/m²) | (mg/m²) |
| Polyethylene | 370 | 106.0 | 15.3 | 5.3 | 4.8 |
| fabric | | | | | |
| All cotton | — | 0 | 0 | 0 | 0 |
| fabric | | | | | |

### Example 2

### Preparation of Insecticidal Polyacryl-Nitrile Yarn

Material: 16.8 tex×4 polyacrylonitrile yarn

The target content of deltamethrin was 0.18%, and the target content of clocythrin was 0.36%, and calculated on a 75% of dye uptake.

Composition of the exhaust dyeing solution:

| Composition | Amount | |
|---|---|---|
| 10% of deltamethrin emulsifiable solution | 0.25 | L |
| 20% of clocythrin emulsifiable solution | 0.25 | L |
| acetic acid | 1.0 | L |
| water | Adding to 100 | L |

10 kg of 16.8 tex×4 polyacrylonitrile yarn was immersed into the exhaust dyeing solution with a pH value of 4 and 5. The exhaust dyeing solution constantly circulated from down to up. And the temperature of the exhaust dyeing solution was increased 1° C. every one minute until 95 to 100° C., and kept for 30 minutes. After exhaust dyeing, the yarn was dried by a centrifugal extractor with the residue solution recycled for the next use together with the newly formulated exhaust dyeing solution. The resultant polyacrylonitrile yarn dried by a dryer can be used for weaving carpets or rugs of acarid and flea proof.

### Example 3

### Preparation of Insecticidal Mosquito Net Fabric

Material: polypropylene mosquito net fabric, density: 50 g/m².

The target content of deltamethrin was 140 mg/m².

Process: by a pad dyeing process.

Equipment: dyeing machine with padding mangle (or stenter, or resin finishing machine).

By double dipping and double padding with a 65% of uptake, the heat treatment temperature was 120° C., and the treatment time was 50 seconds.

Composition of the pad dyeing solution

| Composition | Amount | |
|---|---|---|
| 10% of deltamethrin emulsifiable solution | 5.0 | L |
| acetic acid | 1.0 | L |
| water | Adding to 100 | L |

### Example 4

### Preparation of Insecticidal Polyester/Cotton/Lycra Military Clothing Fabric

Material: fabric made of 40% polyester, 50% cotton and 10% lycra. Weight: 180 g/m².

The target content of deltamethrin was 80 mg/m².

Process: by a pad dyeing process.

Equipment: dyeing machine with padding mangle (or stenter, or resin finishing machine).

By double dipping and double padding with a 85% of uptake, the heat treatment temperature was 180° C., and the treatment time was 90 seconds.

Composition of the pad dyeing solution

| Composition | Amount | |
|---|---|---|
| 10% of deltamethrin emulsifiable solution | 1.0 | L |
| 10% of clocythrin emulsifiable solution | 1.0 | L |
| BPD, adhesive | 6.0 | L |
| methyl ether-etherified melamine, crosslinking agent | 2.5 | L |
| P-toluene sulfonic acid, catalyst | 0.2 | L |
| water | Adding to 100 | L |

### Example 5

### Preparation of Agricultural Insecticidal Net Made of 0.25 mm Fiber Drawn from the Polyethylene Coke Bottle Material

Material: The weight of the fabric was 10 g/m², and the target content of permethrin was 2000 mg/m².

Process: by a pad dyeing process.

Equipment: dyeing machine with padding mangle (or stenter, or resin finishing machine).

By double dipping and double padding with a 35% of uptake, the heat treatment temperature was 90° C., and the treatment time was 190 seconds.

Composition of the pad dyeing solution

| Composition | Amount | |
|---|---|---|
| 10% of deltamethrin emulsifiable solution | 1.6 | L |
| 40% of permethrin emulsifiable solution | 15 | L |
| Alginate, antimigrant | 0.5 | L |
| water | Adding to 100 | L |

### Example 6

### Preparation of Insecticidal Nylon Stockings

The weight of the stockings was 8 g/m². The target content of d-phenothrin was 500 mg/m², calculated on a 75% of uptake Process was exhaust dyeing.

10 kg of nylon stockings were immersed into the exhaust-dyeing solution at the temperature of 90 to 95° C. for 25 minutes. After exhaust dyeing, the nylon stockings were centrifuged to remove the water, and dried and set on a boarding machine.

Composition of the exhaust dyeing solution

| Composition | Amount | |
|---|---|---|
| 10% of deltamethrin emulsifiable solution | 0.2 | L |
| 30% of d-phenothrin emulsifiable solution | 4 | L |
| Acetic acid | 1.0 | L |
| water | Adding to 100 | L |

All references cited herein are incorporated herein by reference.

What is claimed is:

1. A method for preparing insecticidal textiles, characterized in that the synthetic fabrics are dyed with pyrethroids by an exhaust dyeing or a pad dyeing process, wherein the said synthetic fiber fabrics include multifilament, monofilament, and/or staple yarn fabrics of polyester, polyamide, polyurethane, polypropylene, polyethylene, polyacryl-nitrile, or polyvinyl chloride, and their blended or interlaced fabrics with natural fibers, or in that, the synthetic fiber yarns are dyed with the pyrethroids by an exhaust dyeing process, wherein the said synthetic fiber yarns include multifilament, monofilament, and/or staple yarns of the above various fibers, and their blended or interlaced yarns with natural fibers.

2. The method for preparing insecticidal textiles according to the claim 1, characterized in that the said pyrethroids are hydrophobic and insoluble in water, have a molecular weight of less than 700 and a decomposition temperature of higher than the heat treatment temperature for exhaust dyeing or pad dyeing, and have at least one of the following groups: —OH, —CN, —NH₂, —NHR, —NR₂, —NHCOR, —I, —Cl, —Br, —NO₂, —SONH₂,

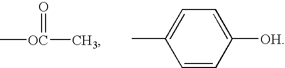

3. The method for preparing insecticidal textiles according to the claim 1 or 2, characterized in that, for the said polypropylene fiber, the exhaust dyeing temperature is 60 to 105° C. and the exhaust dyeing time is 10 to 120 minutes, and the heat treatment temperature for pad dyeing is 85 to 155° C. and the heat treatment time for pad dyeing is 0.2 to 6 minutes.

4. The method for preparing insecticidal textiles according to the claim 1 or 2, characterized in that, for the said polyester fiber, the exhaust dyeing temperature is 60 to 140° C. and the exhaust dyeing time is 10 to 120 minutes, and the heat treatment temperature for pad dyeing is 140 to 215° C. and the heat treatment time for pad dyeing is 0.2 to 4 minutes.

5. The method for preparing insecticidal textiles according to the claim 1 or 2, characterized in that, for the said polyamide fiber, the exhaust dyeing temperature is 65 to 110° C. and the exhaust dyeing time is 10 to 120 minutes, and the heat treatment temperature for pad dyeing is 130 to 200° C. and the heat treatment time for pad dyeing is 0.2 to 4 minutes.

6. The method for preparing insecticidal textiles according to the claim 1 or 2, characterized in that, for the said polyurethane fiber, the exhaust dyeing temperature is 65 to 110° C. and the exhaust dyeing time is 10 to 120 minutes, and the heat treatment temperature for pad dyeing is 150 to 200° C. and the heat treatment time for pad dyeing is 0.2 to 4 minutes.

7. The method for preparing insecticidal textiles according to the claim 1 or 2, characterized in that, for the said polyvinyl chloride fiber, the exhaust dyeing temperature is 50 to 90° C. and the exhaust dyeing time is 10 to 120 minutes, and the heat treatment temperature for pad dyeing is 50 to 100° C. and the heat treatment time for pad dyeing is 0.3 to 7 minutes.

8. The method for preparing insecticidal textiles according to the claim 1 or 2, characterized in that, for the said polyacrylonitrile fiber, the exhaust dyeing temperature is 60 to 120° C. and the exhaust dyeing time is 10 to 120 minutes, and the heat treatment temperature for pad dyeing is 120 to 200° C. and the heat treatment time for pad dyeing is 0.2 to 4 minutes.

9. The method for preparing insecticidal textiles according to the claim 1 or 2, characterized in that, for the said polyethylene fiber, the exhaust dyeing temperature is 40 to 90° C. and the exhaust dyeing time is 10 to 60 minutes, and the heat treatment temperature for pad dyeing is 50 to 100° C. and the heat treatment time for pad dyeing is 0.3 to 7 minutes.
